(19) United States
(12) Patent Application Publication
(10) Pub. No.: US 2019/0291161 A1
(43) Pub. Date: Sep. 26, 2019

(54) PROGRESSIVE PRESS LINE ASSEMBLY

(71) Applicant: MAGNA INTERNATIONAL, INC., Aurora (CA)

(72) Inventor: John R. POTOCKI, Armada, MI (US)

(73) Assignee: MAGNA INTERNATIONAL, INC., Aurora (CA)

(21) Appl. No.: 16/440,152

(22) Filed: Jun. 13, 2019

Related U.S. Application Data
(63) Continuation of application No. 15/537,152, filed on Jun. 16, 2017.
(60) Provisional application No. 62/093,825, filed on Dec. 18, 2014.

(51) Int. Cl. B21D 35/00; G06Q 10/06; B62D 65/18; B21D 53/88

(52) U.S. Cl. CPC B21D 35/002; G06Q 10/06; B23P 11/00; B21D 53/88; B62D 65/18

(57) ABSTRACT

A system for producing a vehicle body assembly is provided. The system comprises an assembly station including a press and a transfer system configured to transfer a metal material to the press. The press is configured to form a vehicle body member from the metal material, and the same press is also configured to connect the vehicle body member with at least one additional vehicle body member to form the vehicle body assembly.

### CROSS-REFERENCE TO RELATED APPLICATIONS

This application is a continuation of U.S. patent application Ser. No. 15/537,152, filed on Jun. 16, 2017, which is a U.S. National Stage of PCT/US2015/064813, filed Dec. 9, 2015, which in turn claims priority to U.S. Provisional Application No. 62/093,825, filed Dec. 18, 2014, each hereby expressly incorporated by reference in its entirety and each assigned to the assignee hereof.

### FIELD

The present patent application relates to a system for producing a vehicle body assembly in a manufacturing facility.

### BACKGROUND

A vehicle manufacturing facility may include a body shop where formed or stamped vehicle body panels are assembled to form vehicle assemblies or sub-assemblies. The body shop may receive formed or stamped vehicle body panels from a stamping facility. The stamping facility may be an on-site facility located in the same manufacturing facility or may be a separate plant located at a distant location (and serving several body shops in different manufacturing facilities). When both the stamping facility and the body shop are within the same vehicle manufacturing facility, the formed vehicle body panels from the stamping facility may be transferred to the body shop for further assembly using a forklift truck or other means of transportation. When both the stamping facility and the body shop are not within the same vehicle manufacturing facility, the formed vehicle body panels from the stamping facility may be delivered to the body shop for assembly by rail, truck or other means of transportation. The process of transferring vehicle body panels from the stamping facility to the body shop may be slow and may require a large amount of equipment. The process of transferring vehicle body panels from the stamping facility to the body shop may also affect the quality of the manufactured product. For example, the vehicle body panels may be damaged during the process of transferring them from the stamping facility to the body shop. Design changes may need to be tracked through the supply chain during the process of transferring the vehicle body panels from the stamping facility to the body shop. Large storage areas may be needed to store the vehicle body panels during the process of transferring of the vehicle body panels from the stamping facility to the body shop. Also, value added time may be lost transferring vehicle body panels from the stamping facility to the body shop.

### SUMMARY

One aspect of the present patent application provides a system for producing a vehicle body assembly in a manufacturing facility. The system includes a forming station configured to form a vehicle body member from a metal material; and an assembly station configured to assemble the vehicle body member with at least one additional vehicle body member to form the vehicle body assembly. The forming station and the assembly station are disposed, in the manufacturing facility, at a predetermined distance from each other, and wherein the predetermined distance is in the range of 0 to 50 feet.

Another aspect of the present patent application provides a forming system for producing a vehicle body assembly in a manufacturing facility. The forming system is configured to form vehicle body members from a metal material and the forming station includes an assembly station configured to assemble the vehicle body members together to form the vehicle body assembly.

Yet another aspect of the present patent application provides a system for producing a vehicle body assembly. The system comprises an assembly station including a press; and a transfer system configured to transfer a metal material to the press. The press is configured to form a vehicle body member from the metal material, and the same press is also configured to connect the vehicle body member with at least one additional vehicle body member to form the vehicle body assembly.

These and other aspects of the present patent application, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the present patent application, the structural components illustrated herein are drawn to scale. It is to be expressly understood, however, that the drawings are for the purpose of illustration and description only and are not intended as a definition of the limits of the present patent application. It shall also be appreciated that the features of one embodiment disclosed herein can be used in other embodiments disclosed herein. As used in the specification and in the claims, the singular form of “a”, “an”, and “the” include plural referents unless the context clearly dictates otherwise.

### BRIEF DESCRIPTION OF THE DRAWINGS

FIG. 1 is a schematic diagram of a system for producing a vehicle body assembly in a manufacturing facility in accordance with an embodiment of the present patent application; and

FIG. 2 is a schematic diagram of a system for producing a vehicle body assembly in a manufacturing facility in accordance with an embodiment of the present patent application.

### DETAILED DESCRIPTION

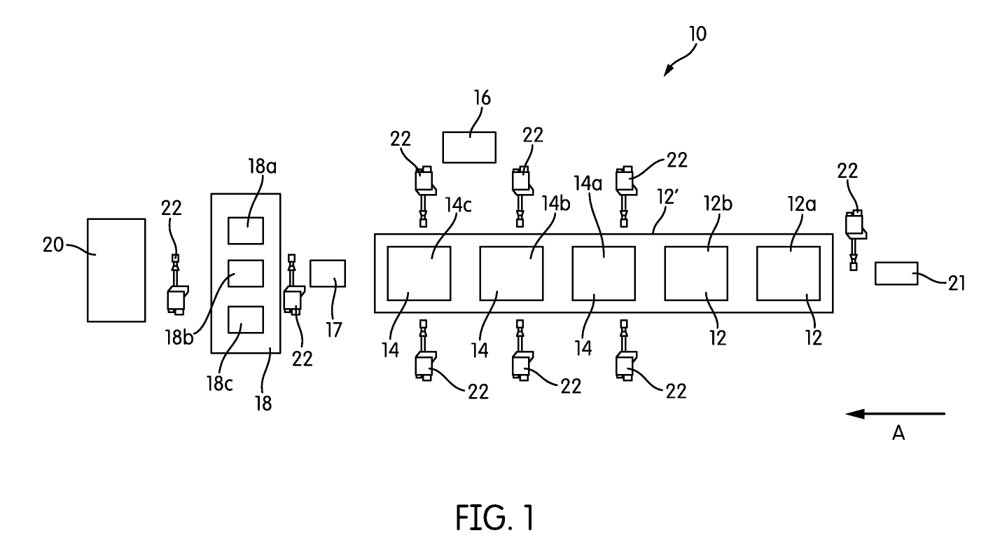

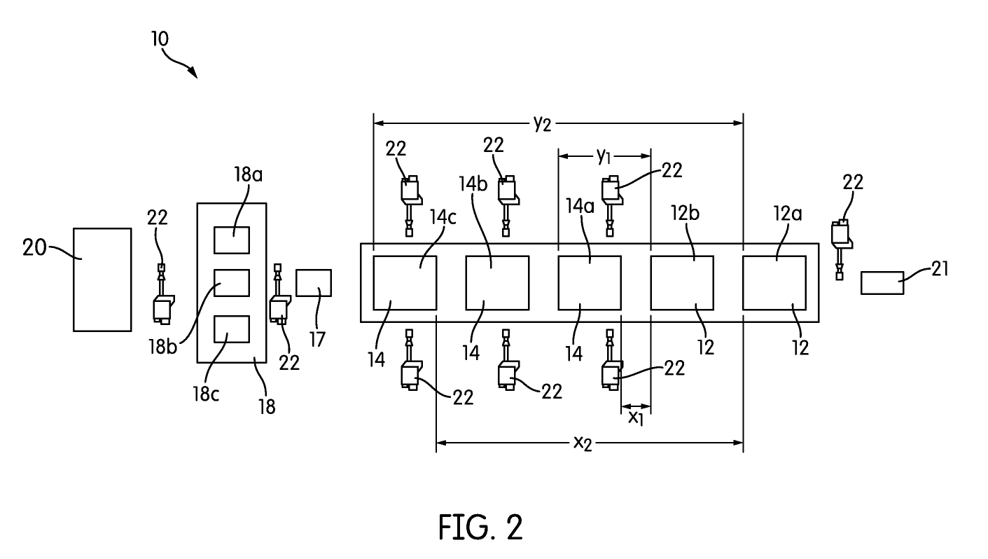

FIGS. 1 and 2 show a system 10 for producing a vehicle body assembly in a manufacturing facility. The system 10 includes a forming station 12 configured to form a vehicle body member from a metal material; and an assembly station 14 configured to assemble the vehicle body member with at least one additional vehicle body member to form the vehicle body assembly. The forming station 12 and the assembly station 14 are disposed, in the manufacturing facility, at a predetermined distance from each other, and wherein the predetermined distance is in the range of 0-50 feet. That is, the predetermined distance is in the range of 0 to 15.24 meters. In another embodiment, the predetermined distance is in the range of 0 to 20 feet.

In one embodiment, referring to FIG. 2, the predetermined distance between the forming station 12 and the assembly station 14 may range between x₁ and x₂. x₁ is the distance between a last forming station 12b and a first assembly station 14a or is the distance between the forming and the assembly stations that are closest to each other. x₂ is the distance between a first forming station 12a and a last assembly station 14c or is the distance between the forming and the assembly stations that are farthest from each other.

In one embodiment, the assembly station 14 is disposed, in the manufacturing facility, within a predetermined distance from the forming station 12, and wherein the predetermined distance is in the range of 0-50 feet (0 to 15.24 meters). For example, the predetermined distance within which the assembly station 14 is disposed from the forming station 12 may range between y₁ and y₂. y₁ is the distance within which the first assembly station 14a is disposed from the last forming station 12b and y₂ is the distance within which the last assembly station 14c is disposed from the first forming station 12a.

In one embodiment, a forming system or press 12′ for producing the vehicle body assembly in the manufacturing facility may include the assembly station 14 configured to assemble the vehicle body members together to form the vehicle body assembly. For example, in one embodiment, the power from the press/forming system 12′ is used to form one or more vehicle body panels, and also used to fold and fasten/secure the vehicle body panels together to form vehicle body assemblies. That is, the energy of the press ram or forming system 12′ may be used to drive assembly operations of the assembly station 14. In one embodiment, the metal raw material is loaded into the press/forming system 12′ in order to build up the vehicle body assembly. In one embodiment, welding, bonding, securing, joining or fastening operations that are used to form or build the vehicle body assembly may be performed inside the press/forming system 12′. In one embodiment, the system 10 includes the press/forming system 12′.

In one embodiment, the system 10 may include a loading station 21, one or more forming stations 12a, 12b, one or more assembly stations 14a, 14b, 14c, a quality control station(s)/quality control system 17, a transfer system 22, a secondary forming or assembly system 16, a post assembly system 18 with one or more post assembly stations 18a, 18b, 18c, and a storage or unloading system 20.

In one embodiment, the one or more forming stations 12a, 12b and one or more assembly stations 14a, 14b, 14c may be together be referred to as the forming system 12′ and may be disposed within a press such that the energy from the forming system/press 12′ may be configured to drive all the forming and assembly stations within the forming system/press 12′.

In one embodiment, the vehicle body assembly components may be loaded in the bottom half of the corresponding dies of the one or more assembly stations 14a, 14b, 14c or one or more forming stations 12a, 12b. In another embodiment, the vehicle body assembly components may be loaded in the top half of the corresponding dies of the one or more assembly stations 14a, 14b, 14c or one or more forming stations 12a, 12b. In yet another embodiment, the vehicle body assembly components may be loaded in both the top half and the bottom half of the corresponding dies of the one or more assembly stations 14a, 14b, 14c or one or more forming stations 12a, 12b. In one embodiment, the vehicle body assembly components may include vehicle body panel members, nuts, studs, bushings, and/or other vehicle body assembly components.

In one embodiment, the loading station 21, the secondary forming or assembly system 16 and the post assembly system 18 may be optional. In one embodiment, the number of forming stations, assembly stations, quality control station(s), secondary forming or assembly stations, and post assembly stations in the system 10 may vary.

In one embodiment, the system 10 may also include a vehicle body assembly component holding station for holding the vehicle body assembly components (including vehicle body panel members, nuts, studs, bushings, and/or other vehicle body assembly components) prior to, during and/or after the processing procedures performed by the one or more assembly stations 14a, 14b, 14c, the one or more forming stations 12a, 12b or one or more secondary forming or assembly stations 16. In one embodiment, the vehicle body assembly component holding station may include one or more vehicle body assembly component holding bins. In one embodiment, the vehicle body assembly component holding station is optional. In one embodiment, in a subsequent, new vehicle body assembly forming procedure, one of the forming stations may be used as an assembly station by simply changing the corresponding dies on the press 12′. In another embodiment, in a subsequent, new vehicle body assembly forming procedure, one of the assembly stations may be used as a forming station by simply changing the corresponding dies on the press 12′. In one embodiment, one of the stations may be configured to perform both forming and assembly operations one after the other.

In one embodiment, the raw material introduced into the system 10 may be moved from one station to another station for processing along the direction of an arrow A. In one embodiment, the raw material may a metal material. For example, the raw material may include steel, Dual-phase steel sheet (e.g., DP600), aluminum, aluminum sheet, aluminum castings, magnesium, magnesium sheet, magnesium castings, coated steel (e.g., galvanized steel), uncoated steel (e.g., bare steel), steel alloys, boron steel, hot stamped steel, aluminum alloys, magnesium alloys, hybrid material, carbon fibers, polymers, and/or composite materials. In one embodiment, the metal material may be in the form of a coil, a strip or a sheet form.

In one embodiment, a developed blank or vehicle body member(s) may be loaded into a loading station 21. In one embodiment, the loading station 21 may be disposed within the press 12′ or may be disposed outside the press 12′. In one embodiment, adhesive(s) or sealer(s) may be applied to the developed blank or vehicle body member(s), as needed, when the developed blank or vehicle body member(s) is at the loading station 21. In one embodiment, the developed blank may include gauge holes.

In one embodiment, the transfer system 22 may be configured to move the developed blank or vehicle body member(s) from the loading station 21 to the forming station 12.

In one embodiment, the vehicle body assembly component holding station may be disposed, in the manufacturing facility, at a predetermined distance from the one or more assembly stations 14a, 14b, 14c or one or more forming stations 12a, 12b such that the vehicle body assembly components may be loaded from the vehicle body assembly component holding station to the one or more assembly stations 14a, 14b, 14c or one or more forming stations 12a, 12b for further processing. In one embodiment, the vehicle body assembly component holding station may be disposed, in the manufacturing facility, at a predetermined distance from one or more secondary forming or assembly stations 16 such that the vehicle body assembly components may be loaded from the vehicle body assembly component holding station to the one or more secondary forming or assembly stations 16 for further processing. In one embodiment, the transfer system 22 may be configured to transfer the vehicle body assembly components from the vehicle body assembly component holding station to the one or more assembly stations 14a, 14b, 14c, the one or more forming stations 12a, 12b or the one or more secondary forming or assembly stations 16.

In one embodiment, the forming station 12 may be configured to form a vehicle body member from the metal material. In one embodiment, the forming station 12 may include a plurality of sequentially, adjacently and longitudinally aligned forming stations 12a and 12b. In the illustrative embodiment, the forming operation may be performed by two forming stations 12a and 12b. However, in one embodiment, it is contemplated that the forming operation may be performed by only one forming station. In another embodiment, it is contemplated that the forming operation may be performed by more than two forming stations. Each forming station 12a, 12b may be configured to perform one or more predetermined forming or stamping operation(s) in a predetermined sequence so as to produce the formed or stamped vehicle body member(s).

In one embodiment, the forming station 12, 12a, or 12b may be configured to perform one or more of the following operations, including, but not limited to, stamping, bending, blanking, flanging, stretching, hemming, piercing, trimming, pressing, drawing, roll forming, hydroforming, or any other metal forming operations. For example, to perform the stamping or forming operation, the forming station 12, 12a, or 12b may include a pair of dies. In one embodiment, the forming station 12, 12a, or 12b may be mechanically, pneumatically or hydraulically driven. In one embodiment, the forming station 12, 12a, or 12b may include a stationary bottom die and a movable (up and down movement/stroke) top die. In one embodiment, the forming station 12, 12a, or 12b may be operatively connected to a programmable logic controller (PLC). The controller may be configured to monitor the amount of force used for each stroke of the stamping die and to control material feed through the forming station 12, 12a, or 12b. In one embodiment, the forming station 12, 12a, or 12b may include a die assembly described in commonly assigned U.S. Pat. No. 6,032,504 that is hereby incorporated by reference in their entirety.

In one embodiment, the forming station 12, 12a, or 12b may be configured to be used with die nuts, clinch nuts, or weld studs. In one embodiment, the die nuts, the clinch nuts, or the weld studs may be used to mount vehicle trim or body components during the vehicle assembly.

In one embodiment, the transfer system 22 may be configured to move the developed blank or vehicle body member(s) from the loading station 21 to the first forming station 12a. In one embodiment, the first forming station 12a may be configured to perform a first stage forming operation on the developed blank or vehicle body member(s).

In one embodiment, the transfer system 22 of the system 10 may be configured to deliver the vehicle body member(s) from one forming station to another forming station, and/or from a forming station to an assembly station. In one embodiment, the transfer system 22 may also be configured to deliver the vehicle body member(s) or vehicle body assembly from one assembly station to another assembly station and/or from an assembly station to the quality control station 17 for quality control and inspection, the storage station 20 for storage or the post assembly system 18 for further processing.

In one embodiment, the transfer system 22 may include a conveyor (e.g., overhead gantry or belt) or a robot system. In the illustrative embodiment, the transfer system 22 may include one or more robots that are disposed at predetermined locations. In one embodiment, the number of robots in the transfer system 22 may vary. In one embodiment, the one or more robots may be part loading or operational robots. In one embodiment, the one or more robots may include changeable end effectors. In one embodiment, the transfer system 22 may be a linear transfer system. In one embodiment, the transfer system 22 may include a combination of a linear transfer system and robots.

In one embodiment, the transfer system 22 may be configured to move the developed blank or vehicle body member(s) from the first forming station 12a to the second forming station 12b. In one embodiment, the second forming station 12b may be configured to perform a second stage forming operation on the developed blank or vehicle body member(s). For example, the second stage forming operation may include additional/further forming operation and a hole punching operation. In one embodiment, the second stage forming operation may include additional/further forming operation and a folding operation.

In one embodiment, the transfer system 22 may be configured to move the developed blank or vehicle body member(s) from the second forming station 12b to the assembly station 14. In one embodiment, the assembly station 14 may each include a plurality of sequentially, adjacently and longitudinally aligned assembly stations 14a, 14b, and 14c. Each assembly station 14a, 14b, 14c may be configured to perform one or more predetermined assembly operation(s) in a predetermined sequence so as to produce the vehicle body assembly. In the illustrative embodiment, the assembly operation(s) may be performed by three assembly stations 14a, 14b, and 14c. However, in one embodiment, it is contemplated that the assembly operation(s) may be performed by only one assembly station. In another embodiment, it is contemplated that the assembly operation(s) may be performed by more than three assembly stations.

In one embodiment, the assembly station 14, 14a, 14b, or 14c may be configured to perform a welding operation, a hemming operation, an adhesive bonding operation, a bonding operation, a fastening operation, a piercing operation, a crimping operation, an electromagnetic crimping operation, a part folding operation, a spot welding operation, a folding operation, a stud welding, a nut welding, or any other joining or assembly operations. In one embodiment, the welding operation may include Gas Metal Arc Welding (GMAW), Metal Insert Gas (MIG) welding, Metal Active Gas (MAG) welding, Tungsten Inert Gas welding (TIG), Gas Tungsten Arc welding (GTAW), resistance welding, laser welding, plasma welding, a solid state welding or any other welding operation in which an electric arc is formed to heat metal vehicle body members causing them to melt, and join.

In one embodiment, the assembly station 14, 14a, 14b, or 14c may be configured to perform fastening in which the vehicle body members to be joined to each other using fastening elements to form the vehicle body assembly. For example, the fastening elements may include studs, rivets (including self-piercing), bolts, nuts, threaded fasteners, retainers, compression limiters, clips, brackets, shear pins, toggle locks, bracketry, etc. For example, fastening may be used to secure the vehicle body members to form vehicle body assemblies, such as engine cradles, control arms, transverse axles, sheet metal sub-assemblies, dash panels, rails, underbody structures, bumper beams, etc.

In one embodiment, the assembly station 14, 14a, 14b, or 14c may be configured to perform part folding operation in which a peripheral portion of one of the vehicle body members is folded back onto a reverse surface of the other of the vehicle body members to form the vehicle body assembly. In one embodiment, adhesives may be applied before folding the vehicle body panels/members. For example, this part folding operation may be used to secure the vehicle body members to form vehicle body assemblies, such as engine cradles, control arms, transverse axles, sheet metal sub-assemblies, dash panels, rails, underbody structures, bumper beams, etc.

In one embodiment, the assembly station 14, 14a, 14b, or 14c may be configured to bond two vehicle body members together to form the vehicle body assembly. In one embodiment, the assembly station may use adhesives to bond two vehicle body members together. In one embodiment, the assembly station may also be configured to apply a pressure force, for a period of time, on the two vehicle body members that are being adhesively bonded so as to promote curing of the adhesive therebetween. In another embodiment, fast curing adhesives may be used to bond two vehicle body members together. In one embodiment, adhesive bonding may be used to form structural hem flanges. In one embodiment, adhesive bonding may be used to form vehicle body assemblies, such as hoods, doors, trunk lids, tailgates, deck lid flanges, roof panels, interior dashboards, body-in-white sub-assemblies, etc.

In one embodiment, the assembly station 14, 14a, 14b, or 14c may be configured to perform stud welding. For example, fastening elements, such as studs, may be welded to the vehicle body member(s). In one embodiment, these fastening elements may serve as anchors for fixing other vehicle components. In one embodiment, opposing faces of the two vehicle body members being joined may be melted onto one another (e.g., using an arc) and a bond may then be created between the vehicle body members and fastening elements, such as a studs. In one embodiment, the studs may be bolts or specially formed nuts. In one embodiment, the assembly station 14, 14a, 14b, or 14c may be configured to perform electromagnetic pulse forming/crimping in which the vehicle body members to be joined to each other are exposed to a very large deformation force so as to form an interlocking connection therebetween. The very large deformation force may be magnetic forces that are created by passing a huge pulse of current through a coil. For example, electromagnetic pulse forming/crimping may be used to secure the vehicle body members to form vehicle body assemblies, such as crushed tubes, bearing sleeves, mounting sleeves, etc.

In one embodiment, the assembly station 14, 14a, 14b, or 14c may be configured to perform a hemming operation to join two vehicle body members together to form the vehicle body assembly. For example, a peripheral edge portion of one of the vehicle body members may be folded toward the other of the vehicle body members to form a hemming flange. The hemming flange may be configured to sandwich the peripheral edge portion of the other of the vehicle body members such that one of the vehicle body members is hemming joined with the other of the vehicle body members. In one embodiment, one of the vehicle body members may be a vehicle door outer panel and the other of the vehicle body members may be a vehicle door inner panel. In one embodiment, the vehicle body members forming a hemming flange may be part of other vehicle components, such as hoods, trunk lids, tailgates, body-in-white sub-assemblies, doors, engine cradles, control arms, and deck lid flanges. In one embodiment, the hemming flanges may be used to provide structural reinforcement to the vehicle body components or vehicle body assemblies.

In one embodiment, when the system is used with Dual-phase (e.g., DP600) steel sheet or other steel materials, no or a few Heat Affected Zones (HAZs) are created. For example, when a welding operation is used to join the stamped vehicle body components (made from Dual-phase (e.g., DP600) steel sheet or other steel materials), Heat Affected Zones are created. That is, the welding operation may introduce or create weakened portion(s) in the vehicle body assembly and may increase ductility of the materials used for the vehicle body assembly. In one embodiment, instead of the welding operation, other operations such as crimping may be used to join or secure the stamped vehicle body components (made from Dual-phase (e.g., DP600) steel sheet or other steel materials) together. Thus, eliminating or reducing the creation of Heat Affected Zones in the vehicle body assembly.

In one embodiment, new vehicle body members, previously formed or stamped vehicle body members, or previously formed vehicle sub-assemblies may be loaded into the system 10 so that the newly loaded vehicle body members, previously formed or stamped vehicle body members or the previously formed vehicle sub-assemblies may be assembled with the vehicle body members or vehicle body assembly in the system 10 to form a new vehicle body assembly.

In one embodiment, the vehicle body assembly being formed in the system 10 may include an engine cradle assembly, a link arm assembly, a door assembly, a pillar assembly, or any other vehicle body assembly. In another embodiment, the vehicle body assembly may include sub-frame assembly, cross beam assembly, frame rail assembly, frame bracket assembly, roof rail assembly, vehicle seat frame assembly, door beam assembly, bumper beam assembly, control arm assembly, wheel assembly, body-in-white sub-assemblies, and instrument panel reinforcements.

In one embodiment, the system 10 may include one or more secondary forming or assembly stations 16. In one embodiment, one or more secondary forming or assembly stations 16 may be disposed, in the manufacturing facility, within a predetermined distance of and within close proximity from the system 10. In one embodiment, the predetermined distance is in the range of 0-50 feet.

For example, in one embodiment, the vehicle body members or the vehicle body assembly may be transferred from the system 10 to one or more secondary forming or assembly stations 16 to perform one or more predetermined operation(s) in a predetermined sequence, and, the vehicle body members or the vehicle body assembly may then be transferred back from the one or more secondary forming or assembly stations 16 to the system 10, after the completion of the one or more predetermined operation(s), for further processing.

For example, in one embodiment, one or more secondary assembly stations 16 may be configured to perform welding operation(s) such as those discussed in detail above. In one embodiment, one or more secondary assembly stations 16 may be configured to perform adhesive bonding operation. In one embodiment, one or more secondary assembly stations 16 may be configured to weld weld nuts to the vehicle body assembly or vehicle body members. For example, weld nuts may be welded around openings that are pre-punched into the vehicle body members or vehicle body assembly.

In one embodiment, the one or more secondary forming or assembly stations 16 may be configured to perform off-line operation(s). That is, the vehicle body members or the vehicle body assembly may be temporarily taken off-line from the system 10 for a brief period of time to perform one or more predetermined operation(s) in the one or more secondary forming or assembly stations 16. In one embodiment, when some of the vehicle body members or the vehicle body assembly may be temporarily taken off-line, the system 10 may continue to perform one or more predetermined operation(s) on other vehicle body members or the vehicle body assembly. In one embodiment, one or more secondary assembly stations 16 may be small weld presses.

In one embodiment, in the system 10, weld count used to join the two vehicle body members together to form the vehicle body assembly may be reduced due to reduction in parts requiring joining. In one embodiment, instead of using a welding operation, an adhesive bonding operation, a crimping operation, or a hemming operation may be used to join or secure the stamped vehicle body components together. Thus, reducing the number of welds (or weld count) required to form the vehicle body assembly.

In one embodiment, the transfer system 22 may be configured to move the vehicle body assembly or the vehicle body member(s) from the first assembly station 14a to the second assembly station 14b and then to third assembly station 14c. In one embodiment, the second assembly station 14b and the third assembly station 14c may be configured to perform a second stage assembly operation and a third stage assembly operation, respectively, on the vehicle body member(s) or the vehicle body assembly. In one embodiment, the second assembly station 14b and/or the third assembly station 14c are optional. In one embodiment, as discussed above, the vehicle body assembly or the vehicle body member(s) may be transferred from the first, second or third assembly stations 14a, 14b, 14c to the secondary assembly station 16 for processing and may then be transferred back to the next (second or third) assembly station 14b, 14c after processing in the secondary assembly station 16. In one embodiment, the vehicle body assembly or the vehicle body member(s) may be first loaded in the one or more secondary forming or assembly stations 16 to perform one or more predetermined operation(s) and then transferred to the one or more forming stations 12a, 12b to perform one or more forming operations and/or the one or more assembly stations 14a, 14b, 14c to perform one or more assembly operations.

In one embodiment, the transfer system 22 may be configured to move the vehicle body assembly from the third forming station 14c or the last forming station to the one or more quality control station(s) or a quality control system 17. For example, the transfer of the vehicle body assembly from the third forming station 14c or the last forming station to the one or more quality control station(s) or a quality control system 17 may be performed by an automated transfer system, a robotic transfer system, or a combination thereof.

The one or more quality control station(s) or the quality control system 17 may be configured to detect defects during the forming or the assembly of the vehicle body assembly. The quality control station 17 may be disposed adjacently and within close proximity to the system 10 and sequentially after the last assembly station 14c. In one embodiment, the quality control system 17 may serve as an unloading station.

In one embodiment, the transfer system 22 may be configured to transfer the vehicle body members or vehicle body assembly from the quality control station 17 to the post assembly system 18 for further processing or to a storage station 20 (e.g., unload racks) for storage.

In one embodiment, the post assembly system 18 may have one or more post assembly stations 18a, 18b, or 18c. In one embodiment, the number of post assembly stations in the post assembly system 18 may vary. In one embodiment, the post assembly system 18 may be optional. In one embodiment, the one or more post assembly stations 18a, 18b, or 18c may be configured to perform a welding operation, a piercing operation, a machining operation, an operation for measuring the vehicle body assembly, a tagging operation, an engraving operation (e.g., for engraving vehicle identification information or vehicle body assembly identification information), a pin insertion operation (e.g., inserting strux pins that are used for alignment during vehicle body assembly), or any other post assembly operations. For example, the welding operation performed by the post assembly stations 18a, 18b, or 18c may include any welding operations that are discussed above. In one embodiment, one or more post assembly stations 18a, 18b, or 18c at the end of the press line may provide more weld time if required. In one embodiment, at one of the post assembly stations 18a, 18b, or 18c, the vehicle body assembly may be clamped and a single sided laser spot welding may be performed as needed.

In one embodiment, unload robots with changeable end effectors may be configured to transfer the vehicle body assembly from the post assembly system 18 to the storage station 20. The vehicle body assembly may be transferred to shipping racks at the storage station 20 for storage. The shipping racks with the vehicle body assemblies may be transported to other parts for the manufacturing facility or to other manufacturing facilities for further processing or assembly. The shipping racks may be configured to securely lock the vehicle body assemblies thereto for transport between manufacturing facilitates or within the manufacturing facility. The shipping racks may be configured to be used with robots to enable the removal of the vehicle body assemblies therefrom.

In one embodiment, welding on high strength steels may be reduced or eliminated, thereby reducing or eliminating the fatigue strength loss issue caused by welding. In one embodiment, instead of using a welding operation, an adhesive bonding operation, a crimping operation, or a hemming operation may be used to join or secure the stamped vehicle body components together.

In one embodiment, the system of the present disclosure may provide a low cost option to change over to a new vehicle body assembly. For example, in one embodiment, only the press tooling and the robot end effectors may need to be changed out to run a new vehicle body assembly. The system of the present disclosure, thus, may provide faster assembly builds. In one embodiment, the system of the present disclosure is configured to cut the assembly time from 60 seconds to approximately 10 seconds per vehicle body assembly. In one embodiment, the system of the present disclosure is configured to cut the assembly time from 60 seconds to approximately 10 seconds per vehicle body assembly. In one embodiment, vehicle cradle may be produced by the system 10 in 12 to 15 seconds when compared to 45 to 60 seconds taken to produce the same cradle by a prior art system.

The system of the present disclosure may also improve/increase the production rate for producing the same vehicle body assembly. In one embodiment, the system of the present disclosure may perform multiple operations (e.g., forming or assembly) simultaneously to improve production rate and to eliminate Work-In-Progress (WIP).

For example, the system of the present disclosure may reduce floor space in the stamping facility by eliminating the need for storage racks or other related equipment for storing and transporting work-in-process vehicle body members (after members have been stamped but before being transferred to the assembly stations/body shop for assembly). This may minimize the stamping facility footprint and maximize the stamping facility area utilization.

The system of the present disclosure may also reduce the overhead cost per vehicle body assembly. The labor costs associated with transporting the vehicle body panels from the stamping facility to the body shop, and the transportation costs associated with transporting the vehicle body panels from the stamping facility to the body shop may be eliminated, thereby, reducing the overall cost of manufacturing the vehicle body assembly.

The manufacturing facility may be a vehicle, car, automotive or automobile manufacturing facility. The manufacturing facility includes the assembly station 14 that receives stamped or formed vehicle body members and forms the vehicle body assemblies. In one embodiment, the assembly station 14 may be part of the forming station 12. In another embodiment, the assembly station 14 and the forming station 12 may be positioned sequentially adjacent to each other a predetermined distance in the range of 0-50 feet.

The manufacturing facility may also include a paint shop (not shown) where the vehicle body assembly, from the body shop, is painted with a primer coating, one or more color coating(s) and one or more clear coating(s). The manufacturing facility may also include a chassis facility where the painted vehicle body assembly is attached or coupled to vehicle chassis and powertrain components (including vehicle engine, vehicle transmission, and vehicle drive shafts). The manufacturing facility may also include a general assembly facility where interior vehicle components, some exterior vehicle components, vehicle doors and trim panels, and vehicle seating are attached to the vehicle assembly from the chassis facility.

In another embodiment, the manufacturing facility may include the assembly station 14 and the forming station 12 and may not include the paint shop, chassis facility, and general assembly.

Although the present patent application has been described in detail for the purpose of illustration, it is to be understood that such detail is solely for that purpose and that the present patent application is not limited to the disclosed embodiments, but, on the contrary, is intended to cover modifications and equivalent arrangements that are within the spirit and scope of the appended claims. In addition, it is to be understood that the present patent application contemplates that, to the extent possible, one or more features of any embodiment can be combined with one or more features of any other embodiment.

What is claimed is:

1. A system for producing a vehicle body assembly comprising:
an assembly station including a press; and
a transfer system configured to transfer a metal material to the press,
the press configured to form a vehicle body member from the metal material, and
wherein the same press is also configured to connect the vehicle body member with at least one additional vehicle body member to form the vehicle body assembly.

2. The system of claim 1, wherein energy from the press drives the forming of the vehicle body member from the metal material and wherein the energy from the press also drives the connecting of the vehicle body member with at least one additional vehicle body member to form the vehicle body assembly.

3. The system of claim 1, wherein the transfer system is configured to transfer the vehicle body assembly from the press.

4. The system of claim 1, wherein the metal material is selected from a group consisting of steel, Dual-phase sheet steel, aluminum, magnesium, steel alloys, aluminum alloys, magnesium alloys, hybrid and composite materials.

5. The system of claim 1, wherein the vehicle body member is formed using one or more of the following operations: stamping, bending, blanking, flanging, stretching, hemming, trimming, pressing, drawing, roll forming, and hydroforming operations.

6. The system of claim 1, wherein the vehicle body member is connected with at least one additional vehicle body member to form the vehicle body assembly using one or more of the following operations: welding, hemming, adhesive bonding, bonding, fastening, piercing, crimping, electromagnetic crimping, part folding, folding, stud welding, and nut welding.

7. The system of claim 1, wherein the vehicle body assembly is selected from a group consisting of an engine cradle assembly, a link arm assembly, a door assembly, a pillar assembly, a sub-frame assembly, a cross beam assembly, a frame rail assembly, a frame bracket assembly, a roof rail assembly, a seat frame assembly, a door beam assembly, a bumper beam assembly, a control arm assembly, and an instrument panel reinforcement.

8. The system of claim 1, wherein the same assembly station is configured to apply a deformation force to the vehicle body member and/or the at least one additional vehicle body member to form an interlock connection therebetween so as to connect the vehicle body member and at least one additional vehicle body member to form the vehicle body assembly.

9. The system of claim 8, wherein the deformation force includes magnetic forces that are created by passing a pulse of current through a coil.

10. The system of claim 8, wherein the vehicle body assembly is selected from a group consisting of crushed tubes, bearing sleeves, and mounting sleeves.

11. The system of claim 1, wherein the same assembly station is configured to fold a peripheral edge portion of one of the vehicle body member and the at least one additional vehicle body member towards the other of the vehicle body member and the at least one additional vehicle body member to form an interconnection therebetween so as to connect the vehicle body member and at least one additional vehicle body member to form the vehicle body assembly.

12. The system of claim 11, wherein the interconnection between the vehicle body member and the at least one additional vehicle body member includes a hemming flange.

13. The system of claim 12, wherein the hemming flange between the vehicle body member and the at least one additional vehicle body member is configured to provide structural reinforcement to the vehicle body assembly.

14. The system of claim 12, wherein the hemming flange is configured to sandwich the peripheral edge portion of the other of the vehicle body member and the at least one additional vehicle body member such that one of the vehicle body member and the at least one additional vehicle body member is hem joined with the other of the vehicle body member and the at least one additional vehicle body member.

15. The system of claim 11, wherein one of the vehicle body member and the at least one additional vehicle body member includes a vehicle door outer panel and the other of the vehicle body member and the at least one additional vehicle body member includes a vehicle door inner panel.

16. The system of claim 11, wherein the vehicle body assembly is selected from a group consisting of hoods, trunk lids, tailgates, body-in-white sub-assemblies, doors, engine cradles, control arms, and deck lid flanges.

17. The system of claim 1, wherein the same assembly station is configured to fold a peripheral portion of one of the vehicle body member and the at least one additional vehicle body member is back onto a reverse surface of the other of the vehicle body member and the at least one additional vehicle body member to form an interconnection therebetween so as to connect the vehicle body member and at least one additional vehicle body member to form the vehicle body assembly.

18. The system of claim 17, wherein the vehicle body assembly is selected from a group consisting of as engine cradles, control arms, transverse axles, sheet metal sub-assemblies, dash panels, rails, underbody structures, and bumper beams.

19. The system of claim 1, wherein the same assembly station is configured to connect the vehicle body member and the at least one additional vehicle body member using fastening elements to form the vehicle body assembly.

20. The system of claim 19, wherein the vehicle body assembly is selected from a group consisting of engine cradles, control arms, transverse axles, sheet metal sub-assemblies, dash panels, rails, underbody structures, and bumper beams.

21. The system of claim 19, wherein the fastening elements are selected from a group consisting of studs, rivets, self-piercing rivets, bolts, nuts, threaded fasteners, retainers, compression limiters, clips, brackets, shear pins, toggle locks, and bracketry.

22. The system of claim 1, wherein the same assembly station is configured to bond the vehicle body member and the at least one additional vehicle body member together to form an interconnection therebetween so as to connect the vehicle body member and at least one additional vehicle body member to form the vehicle body assembly.

23. The system of claim 22, wherein the vehicle body member and the at least one additional vehicle body member are bonded together using adhesives.

24. The system of claim 22, wherein a pressure force, for a period of time, is applied on both vehicle body member and the at least one additional vehicle body member that are being adhesively bonded so as to promote curing of an adhesive therebetween.

25. The system of claim 22, wherein the vehicle body assembly is selected from a group consisting of hoods, doors, trunk lids, tailgates, deck lid flanges, roof panels, interior dashboards, and body-in-white sub-assemblies.

26. The system of claim 1, wherein the same assembly station is configured to attach fastening elements to one of the vehicle body member and the at least one additional vehicle body member, and wherein the fastening elements are configured to serve as anchors for fixing the other of the vehicle body member and the at least one additional vehicle body member.

27. The system of claim 26, wherein opposing faces of the vehicle body member and the at least one additional vehicle body member that being connected are configured to be melted onto one another and wherein an interconnection is created between the vehicle body member, the at least one additional vehicle body member and the fastening elements.
